(19) United States
(12) Patent Application Publication
(10) Pub. No.: US 2020/0339049 A1
(43) Pub. Date: Oct. 29, 2020

(54) SYSTEM AND METHOD OF OPERATING DISPLAY INSIDE MIRROR

(71) Applicants: Hyundai Motor Company, Seoul (KR); Kia Motors Corporation, Seoul (KR)

(72) Inventors: Hyun Joong Pyun, Hwaseong (KR); Byung Seob Yu, Osan (KR); Young Ik Cho, Hwaseong (KR); Nak Kyoung Kong, Seongnam (KR); Hyeon Jo, Yongin (KR)

(21) Appl. No.: 16/697,464

(22) Filed: Nov. 27, 2019

(30) Foreign Application Priority Data
Apr. 23, 2019 (KR) 10-2019-0047155

(51) Int. Cl. B60R 16/03; B60R 1/12; B60R 11/02; H04N 5/63

(52) U.S. Cl. CPC B60R 16/03; B60R 1/12; B60R 2011/0033; H04N 5/63; B60R 2001/1215; B60R 11/0235

(57) ABSTRACT

A method is provided for operating a display inside mirror for driving a display unit in response to a driving request of a user and a change in the driving request to provide a rear visual field to the user. The method includes determining whether a display unit is set to an operation mode and when the display unit is set to the operation mode, determining whether a driving condition is satisfied. When the driving condition is not satisfied whether the determined driving condition is changed is determined prior to determination of the driving condition. The controller is configured to operate the display unit when the driving condition is changed and convert the display unit to an off state when the driving condition is not changed.

### CROSS-REFERENCE TO RELATED APPLICATION

This application claims under 35 U.S.C. § 119(a) the benefit of priority to Korean Patent Application No. 10-2019-0047155 filed on Apr. 23, 2019, the entire contents of which are incorporated herein by reference.

### BACKGROUND

### (a) Technical Field

The present disclosure relates to an operation of operating a display inside mirror, and more particularly, to an operation of operating a display inside mirror for determining an operation mode of a display inside mirror, a driving condition, and a change in the driving condition and driving a display in response to a user request when the display inside mirror configured to provide a rear image of a vehicle as the vehicle is turned off.

### (b) Background Art

A display inside mirror is configured to provide images received through cameras positioned at a rear part or rear-side part of a vehicle through an inside mirror positioned in the vehicle, and recently, has been provided to more easily ensure a rear visual field of the vehicle. The display inside mirror is also configured to be positioned on a bottom surface of a mirror part inside the same housing as the housing in which a conventional inside mirror is positioned, and thus is capable of providing a rear visual field to a user without changes in the indoor layout of the vehicle, thereby minimizing a sense of unfamiliarity experienced by the user.

However, the display inside mirror provides a rear visual field through a display only when a vehicle is turned on, and thus a rear visual field is unable to be provided when the vehicle is turned off. In addition, for a display inside mirror that includes a switch configured to operate a display based on an operation of a tilting lever, a rear visual field provided through a mirror part is also blocked.

Accordingly, according to current trends, there has been a need for a method of constantly providing a rear visual field in response to a user request even when a vehicle is turned off in consideration of the above problems.

### SUMMARY

The present disclosure provides a method of operating a display inside mirror for driving a display unit in consideration of an operation mode and a driving condition in a state in which a vehicle is turned off.

In another aspect, the present disclosure provides a method of operating a display inside mirror for determining a change in a driving condition, which occurs prior to determination of the driving condition, to more accurately consider a user request for a rear visual field and operating a display in response to the user request, instead of merely considering the vehicle state at the time point of determining the driving condition. In addition, the present disclosure provides a display inside mirror for providing a rear visual field based on a driving request of a user.

The objects of the present disclosure are not limited to the objects as mentioned above, and other unmentioned objects will be understood by those skilled in the art from the following description and will be more clearly appreciated by the exemplary embodiments of the present disclosure. In addition, the object of the present disclosure may be realized by devices disclosed in the claims and combinations thereof.

The method of operating a display inside mirror for achieving the above objects of the present disclosure may have the following configurations. In an exemplary embodiment, a method of operating a display inside mirror may include determining whether a display unit is set to an operation mode, by a controller, when the display unit is set to the operation mode, determining whether a driving condition is satisfied, by the controller, and when the driving condition is not satisfied, determining whether the determined driving condition is changed prior to determination of the driving condition, by the controller. The controller may be configured to operate the display unit when the driving condition is changed, and convert the display unit to an off state when the driving condition is not changed.

Whether the display unit is set to the operation mode may be determined when a vehicle is turned off and a switch of the display unit is turned on. The driving condition may include determining whether a vehicle is turned on, determining whether a door is closed when the vehicle is turned off, and determining whether there is a lock and unlock signal of the door when the door is closed. The display unit may be converted to an on state when the vehicle is turned on, the door is open, or the unlock signal of the door is applied. The display unit may be converted to an off state when the lock signal of the door is applied in a state in which the vehicle is turned off and the door is closed. Additionally, the determination of whether the driving condition is changed may include determining whether the door is converted to a closed state from an open state or whether the vehicle is changed to an off state from an on state.

The method may further include setting a counter value based on a user request when the driving condition is changed. When a counter value set according to whether the driving condition is changed is 0, the display unit may be converted to an off state. The method may return to an initial operation after the display unit is operated. The controller may be configured to operate the display unit when the driving condition is satisfied.

### BRIEF DESCRIPTION OF THE DRAWINGS

The above and other features of the present disclosure will now be described in detail with reference to exemplary embodiments thereof illustrated in the accompanying drawings which are given hereinbelow by way of illustration only, and thus are not limitative of the present disclosure, and wherein:

FIG. 1 is a diagram showing the configuration of an apparatus of a display inside mirror according to an exemplary embodiment of the present disclosure;

FIG. 2 is a flowchart of a method of operating a display inside mirror according to an exemplary embodiment of the present disclosure;

FIG. 3 is a flowchart of determination of a driving condition of a display inside mirror according to an exemplary embodiment of the present disclosure; and

FIG. 4 is a flowchart of an operation of determining whether a driving condition of a display inside mirror is changed according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present disclosure will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Also, the terms, such as ‘unit’ or ‘module’, etc., should be understood as a unit that processes at least one function or operation and that may be embodied in a hardware manner, a software manner, or a combination of the hardware manner and the software manner.

The present disclosure relates to an inside mirror 100 and relates to a display inside mirror 100 having a mirror part and a display unit 110 positioned on a bottom or front surface of the mirror part exposed through an opening of a housing of the inside mirror 100 and that provides a rear visual field to a user through the inside mirror 100. The display inside mirror 100 according to the present disclosure may include the inside mirror 100 configured to supply power to the display unit 110 by an operation of a tilting lever to display a rear visual field through the display unit 110, and in more detail, may include both the display inside mirror 100 driven in a manual operation mode and the display inside mirror 100 that is automatically operated.

An operation mode according to the present disclosure may refer to a state in which a switch is turned on to maintain an on state of the display unit 110 in the display inside mirror 100 in the manual operation mode and may include the case in which the display unit 110 is set to be driven or the display unit 110 is set to be driven in an on state when a vehicle is turned off in the display inside mirror 100 that is automatically operated.

According to the present disclosure, a driving condition may be determined by an operation of determining whether a vehicle is turned on or off, whether a door is closed or open, and whether a lock signal/unlock signal of the door is applied, and in the operation, whether a vehicle is turned on or off, a door is closed or open, and whether a lock signal/unlock signal is applied may be sequentially or simultaneously determined. In addition, when whether the driving condition is determined, if the driving condition is not satisfied, whether a door is changed to a closed state from an open state or whether a vehicle is changed to an off state from an on state up to the time point of determining the driving condition may be determined from the time point prior to determination of the driving condition.

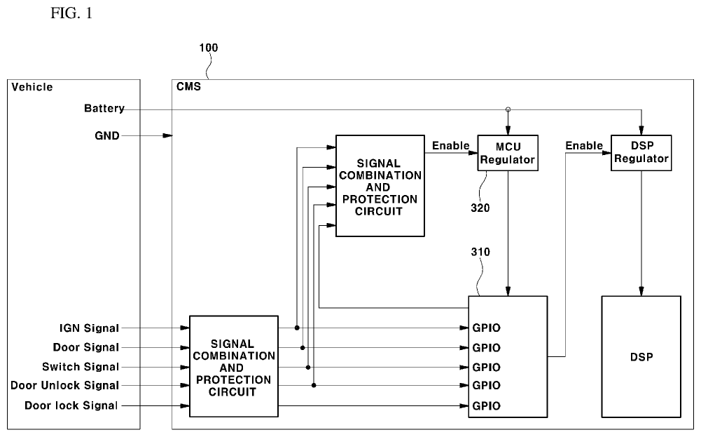

FIG. 1 is a diagram showing the configuration of an apparatus of the display inside mirror 100 according to an exemplary embodiment of the present disclosure. As shown in the drawing, the apparatus may include the inside mirror 100 positioned inside a vehicle, and the inside mirror 100 may include a mirror part (not shown) for providing a rear visual field through a mirror and the display unit 110 disposed on at least one surface of the mirror part. The display unit 110 may be driven by receiving power from a battery (not shown) mounted within the vehicle, and thus, in response to receiving a user request or a driving condition, or when the driving condition is changed, power may be supplied to the display unit 110 from the battery.

The apparatus of the display inside mirror 100 may include a controller 300 configured to supply power to the display unit 110. The controller 300 may include a micro control unit (MCU) 310, an electronic control unit (ECU), and the like and may be configured to receive and store data related to whether a vehicle door is closed or open, whether lock and unlock signals of the vehicle are received, and whether the vehicle is turned on or off. When at least one of the determination factors of the driving condition that occurs in the vehicle is measured at a determination time point, the controller 300 may be configured to supply power to the display unit 110, and thus may be configured to drive a regulator positioned in the display unit 110. According to a signal transmitted to the MCU 310, the MCU 310 may be configured to drive a regulator of a digital signal processor (DSP) and to the DSP.

As described above, when a rear-side image may be displayed on a display, a regulator of a rear-side watching camera unit 200 may be operated, and power may be supplied to the rear-side watching camera unit 200 through the regulator to process an image signal. In other words, the MCU 310 according to the present disclosure may be configured to determine whether there is a driving condition or whether the driving condition is changed prior to determining the driving condition and to drive the display unit 110 to display a rear-side image.

A plurality of signals received as described above may be transmitted to an MCU regulator 320, and thus, when a condition such as a smart key signal, an ignition (IGN) signal, a door closing and opening signal, or a switch signal of the rear-side watching camera unit 200 is satisfied, power may be supplied to the MCU 310 to operate the rear-side watching camera unit 200. In particular, according to the present disclosure, when power is supplied to the display unit 110 to provide an image captured by the camera unit 200 positioned in the vehicle to a user through the display unit 110, the controller 300 may be configured to adjust the image received from the camera unit 200 to provide the same visual field as the visual field provided from the mirror part.

The driving condition measured by the vehicle may include whether a vehicle is turned on, whether a door is closed, whether an unlock signal of the door is received, and the like, and when at least one of the determination factors of the driving condition is satisfied, the controller 300 may be configured to supply power to the display unit 110. In response to receiving the lock signal of the vehicle, the controller 300 may be configured to operate the display unit 110 to be converted to an off state.

Additionally, the controller 300 may be configured to determine whether the driving condition is changed, and in particular, may be configured to determine whether a door is changed to a closed state from an open state or whether a vehicle is changed to an off state from an on state up to the time point of determining the driving condition, from a time point prior to determination of the driving condition. With regard to the determination of whether the driving condition is changed, when determining that a vehicle door is changed to a closed state from an open state or that a vehicle is changed to an off state from an on state, the controller 300 may be configured to set a preset counter value and to supply power to the display unit 110.

As described above, when the controller 300 considers determination factors of the driving condition, if at least one determination factor is satisfied, the controller 300 may be configured to supply power to the display unit 110. However, when none of the determination factors considered as the driving condition are satisfied, the controller 300 may be configured to determine whether the driving condition is changed up to the time point of determining the driving condition, from the time point prior to determination of the driving condition. Accordingly, the controller 300 may be configured to supply power to the display unit 110 in an off state based on a user request up to the time point of determining the driving condition, from the time point prior to determination of the driving condition.

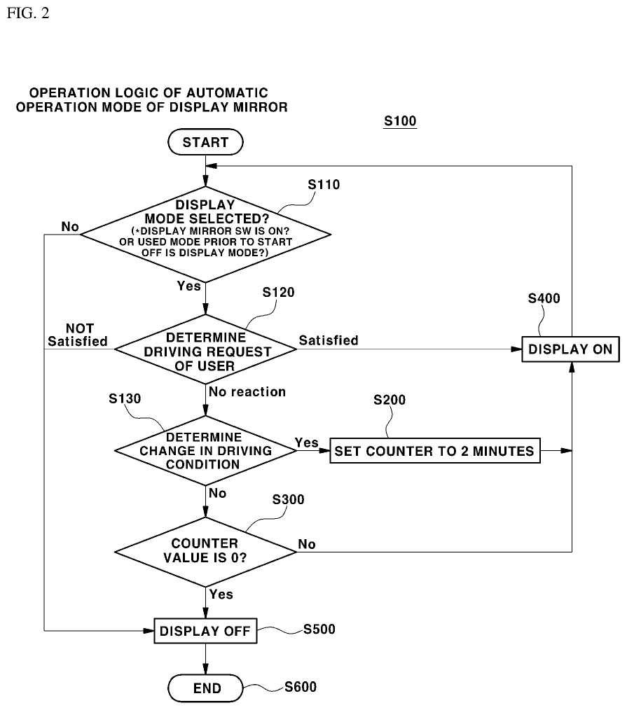

FIG. 2 is a flowchart of a method S100 of operating the display inside mirror 100 according to an exemplary embodiment of the present disclosure. As shown in the drawing, the controller 300 of a vehicle may be configured to determine whether the display unit 110 is set to an operation mode when the vehicle is turned off (S110).

According to an exemplary embodiment of the present disclosure, with regard to the determination of whether the display unit 110 is set to the operation mode when the vehicle is turned off, the display unit 110 may be operated based on a switch input. According to another exemplary embodiment of the present disclosure, the display unit 110 may be configured to be set to the operation mode without separate manipulation. The case in which the display inside mirror 100 is configured to be set to the operation mode via manipulation of a switch may pertain to switch input for maintaining the state of the display unit 110.

When the display unit 110 is operated automatically, the display unit 110 may be determined to be set to the operation mode even when a vehicle is turned off. Accordingly, when the display unit 110 is determined to be set to the operation mode while the vehicle is turned off (S110), whether there is a driving request of a user may be determined (S120). When the driving request of the user is detected, power may be supplied to the display unit 110 to display an image captured by the camera unit 200 positioned at a rear part or rear-side part of the vehicle on the display unit 110 (S400).

In particular, when at least one of determination factors of the driving condition is satisfied, a rear visual field received through the camera unit 200 may be displayed on the display unit 110. When a closed state of the vehicle door is maintained and a lock signal of the vehicle is applied in an off state, the display unit 110 may be turned off (S500) and the logic may be terminated (S600).

According to an exemplary embodiment of the present disclosure, the driving request of the user may be configured to include each determination factor. The determination factors, including whether a vehicle is turned off, whether a vehicle door is maintained in a closed state, and whether a lock signal or an unlock signal of the vehicle door is applied may be determined sequentially or simultaneously. Particularly, a user intention to stop may be determined based on the determination factor of the driving condition of whether a vehicle is turned off, and whether a user intends to maintain a state in which the user is in the vehicle may be determined based on the determination factor of determining whether the vehicle door is maintained in a closed state. In addition, whether the user completes parking may be determined based on the determination factor of whether the lock signal or the unlock signal of the vehicle door is applied.

According to the present disclosure, a user intention to stop may be determined in advance and in response to detecting the user intention to stop, the vehicle door may be determined to be in a closed state, and when the vehicle door is in the closed state, whether the lock signal or the unlock signal of the vehicle door is applied may be determined, and accordingly, the driving condition may include the three above determination factors.

When a driving request of the user is not detected or the determination condition is not satisfied, whether the driving condition is changed may be determined (S130). Whether the driving condition is changed may be determined by determining whether a door is changed to a closed state from an open state or whether a vehicle is changed to an off state from an on state up to the time point of determining the driving condition, from the time point prior to determination of the driving condition.

In other words, in the above operation of determining whether the driving condition is changed, a change between closed and open states of the door and a change between on and off states, for determining whether the driving condition is changed, may be determined at the time point prior to determination of the driving condition. Accordingly, whether determination factors of the driving condition are changed may be determined between the time point of determining the driving condition and a preset time point prior to determination of the driving condition.

When a change in the driving condition is determined, whether a state of the determination factor is changed at the time point of determining the driving condition may be determined by determining, in advance, whether a door is converted into a closed state from an open state and determining whether a vehicle is changed to an off state from an on state. In other words, when a vehicle is turned off at the time point of determining the driving condition, a door is in a closed state, and a lock/unlock signal of the door is not applied at the time point of determining the driving condition, whether the driving condition is changed may be determined prior to determination of the driving condition and in this case, whether the door is converted to a closed state from an open state and a user is operating the vehicle may be determined in advance, and sequentially, whether the vehicle is converted to a stopped or parked state from a driving state of the vehicle may be determined.

When the driving condition is changed, a counter value that corresponds to a preset time may be set (S200), and power may be supplied to the display unit 110 to provide a rear-side visual field to a user through the display unit 110 (S400). However, when the driving condition is not changed (e.g., remains unchanged), whether the preset counter value is 0 may be determined (S300). When the counter value is 0, the display unit 110 may be converted into an off state (S500), and when the counter value is not 0, the display unit 110 may be maintained in an on state (S400).

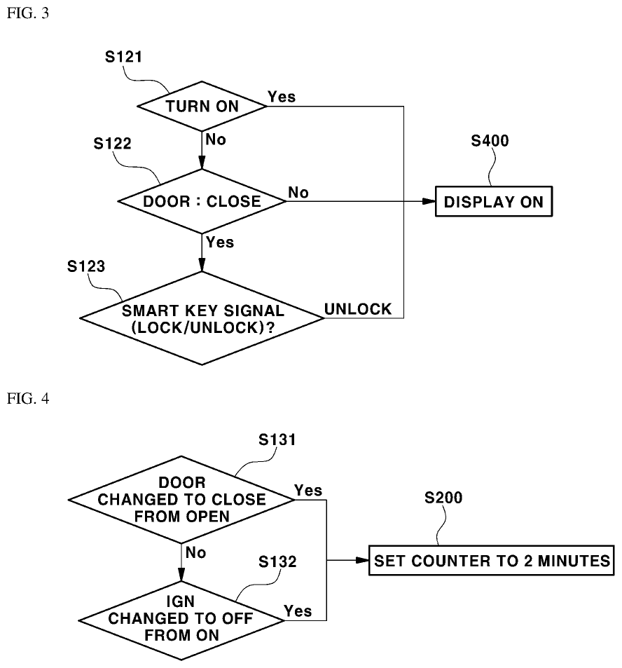

FIG. 3 is a flowchart of determination of a driving condition according to an exemplary embodiment of the present disclosure. As described above, whether an on state is maintained may be determined in advance based on a determination factor of the driving condition (S121) and when a vehicle is turned off, whether a door is closed may be determined (S122). When the door is determined to be closed, whether a lock signal or an unlock signal of the door is applied may be sequentially determined (S123).

With regard to determination of the driving condition, when at least one of a condition in which the vehicle is turned on, a condition in which the door is open, or a condition in which the unlock signal of the door is applied is satisfied, power may be supplied to the display unit 110 to display an image captured by the camera unit 200 positioned outside the vehicle on the display unit 110 (S400). The determination factors of the driving condition may include operation S121 of determining whether the vehicle is turned on to determine a stop or park request of the vehicle, operation S122 of determining whether the door is open to determine whether the user exits the vehicle, and operation S123 of determining whether the lock signal or the unlock signal of the vehicle door is applied from the outside, which may be performed sequentially.

In the operation of determining whether the lock signal of the door is applied, when the unlock signal of the door is applied (S123), power may be supplied to the display unit 110 (S400), and when the lock signal of the door is applied (S123), the display unit 110 may be converted to an off state (S500). However, when the lock signal of the door is not applied (S123), whether the driving condition is changed may be determined (S130). In particular, according to the present disclosure, in operation S120 of determining whether there is the driving request of the user, operation S121 of determining whether the vehicle is turned on, operation S122 of determining whether the door is open, and operation S123 of determining whether the lock/unlock signal of the door is applied, with respect to one time point, may be performed sequentially.

However, the operation S130 of determining whether the driving condition is changed, may include determining whether the determination factors are changed up to the time point of determining the driving condition, from a preset time point prior to determination of the driving condition, and operation S130 may include an operation of determining whether the user exits the vehicle and whether the vehicle is converted to a stopped and parked state.

FIG. 4 is a flowchart of operation S130 of determining whether the driving condition is changed according to an exemplary embodiment of the present disclosure. As shown in the drawing, when none of the determination factors of the driving condition are satisfied (S120), whether the driving condition is changed may be determined (S130). In particular, whether the driving condition is changed may be determined by determining whether a determination factor generated prior to determination of the driving condition is changed, and when a vehicle is turned off (S121), the door is closed (S122), and no smart key signal is present or detected (S123) at the time point of determining the driving condition, whether the driving condition is changed may be determined (S130).

Whether the driving condition is changed may be determined based on whether a determination factor generated prior to determination of the driving condition is changed. According to an exemplary embodiment of the present disclosure, whether the door is changed to a closed state from an open state may be determined (S131), and whether the vehicle is changed to an off state from an on state may be determined (S132). Particularly, according to an exemplary embodiment of the present disclosure, when the door is changed to a closed state from an open state (S131) or the vehicle is changed to an off state from an on state (S132), power may be supplied to the display unit 110 for a predetermined time period (S200).

According to an exemplary embodiment of the present disclosure, when the driving condition is changed, a counter value may be set to about 2 minutes and the display unit 110 may be operated for a time period that corresponds to the counter value. In other words, according to the present disclosure, determination factors at the time point of determining the driving condition may be first compared with a state of the vehicle to determine whether there is a driving request of the user (S120), and then, whether the determination factor, generated up to the time point of determining the driving condition, is changed may be considered from the time point of determining the driving condition (S130). Accordingly, a change in a vehicle state, which occurs up to the time point of determining the driving condition, may be considered from the time point of determining the driving condition and power may be supplied to the display unit 110.

Particularly, when the driving condition is detected, whether there is a user request for ensuring a rear visual field may be determined. When the driving condition is not detected, a change in a determination factor, which occurs up to the time point of determining the driving condition, may be considered to determine whether there is a user request for providing a rear visual field, from the time point of determining the driving condition, and in this case, the display inside mirror 100 may be configured to apply various types of driving requests of a user and to provide a rear visual field through the display unit 110.

The present disclosure may have the following effects in the exemplary embodiments owing to the above configuration, combination, and usage relationship. According to the present disclosure, a request may be more accurately measured to provide a rear visual field based on a driving request of a user and a change in a driving condition prior to determination of the driving condition. In addition, according to the present disclosure, a rear visual field corresponding to a user request may be provided to provide a more stable environment in which the user exits a vehicle.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A method of operating a display inside mirror, comprising:
determining, by a controller, whether a display unit is set to an operation mode;
determining, by the controller, whether a driving condition is satisfied when the display unit is set to the operation mode; and
determining, by the controller, whether the determined driving condition is changed prior to determination of the driving condition when the driving condition is not satisfied,
wherein the controller is configured to operate the display unit when the driving condition is changed, and convert the display unit to an off state when the driving condition is not changed.

2. The method of claim 1, wherein the operation mode is determined to be set to the operation mode when a vehicle is turned off and a switch of the display unit is turned on.

3. The method of claim 1, wherein the driving condition includes:
determining, by the controller, whether a vehicle is turned on;
determining, by the controller, whether a door is closed when the vehicle is turned off; and
determining, by the controller, whether there is a lock and unlock signal of the door when the door is closed.

4. The method of claim 3, wherein the display unit is converted to an on state when the vehicle is turned on, the door is open, or the unlock signal of the door is applied.

5. The method of claim 3, wherein the display unit is converted to an off state when the lock signal of the door is applied, the vehicle is turned off, and the door is closed.

6. The method of claim 1, wherein the determining of whether the driving condition is changed includes determining whether the door is converted to a closed state from an open state or whether the vehicle is changed to an off state from an on state prior to determination of the driving condition.

7. The method of claim 1, further comprising:
setting, by the controller, a counter value based on a user request when the driving condition is changed.

8. The method of claim 7, wherein, when the driving condition is not changed, whether a set counter value is 0 is determined, the display unit is converted to an off state when the counter value is 0, and the display unit is maintained in an on state when the counter value is not 0.

9. The method of claim 1, wherein the method returns to an initial operation after the display unit is operated.

10. The method of claim 1, wherein the controller is configured to operate the display unit when the driving condition is satisfied.

11. A system for operating a display inside mirror, comprising:
a memory configured to store program instructions; and
a processor configured to execute the program instructions, the program instructions when executed configured to:
determine whether a display unit is set to an operation mode;
determine whether a driving condition is satisfied when the display unit is set to the operation mode; and
determine whether the determined driving condition is changed prior to determination of the driving condition when the driving condition is not satisfied,
wherein the processor is configured to operate the display unit when the driving condition is changed, and convert the display unit to an off state when the driving condition is not changed.

12. The system of claim 11, wherein the display unit is determined to be set to the operation mode when a vehicle is turned off and a switch of the display unit is turned on.

13. The system of claim 11, wherein the driving condition includes:
determining whether a vehicle is turned on;
determining whether a door is closed when the vehicle is turned off; and
determining whether there is a lock and unlock signal of the door when the door is closed.

14. The system of claim 13, wherein the display unit is converted to an on state when the vehicle is turned on, the door is open, or the unlock signal of the door is applied.

15. The system of claim 13, wherein the display unit is converted to an off state when the lock signal of the door is applied, the vehicle is turned off, and the door is closed.
